(19) United States
(12) Patent Application Publication
(10) Pub. No.: US 2010/0111004 A1
(43) Pub. Date: May 6, 2010

(54) METHOD OF TRANSMITTING DATA EMPLOYING DATA OPERATION PATTERN

(75) Inventors: Seung June Yi, Gyeongki-do (KR); Young Dae Lee, Gyeongki-do (KR); Sung Duck Chun, Gyeongki-do (KR); Sung Jun Park, Gyeongki-do (KR)

Correspondence Address: MCKENNA LONG & ALDRIDGE LLP, 1900 K STREET, NW, WASHINGTON, DC, 20006, US

(73) Assignee: LG ELECTRONICS, INC., Seoul (KR)

(21) Appl. No.: 12/449,105

(22) PCT Filed: Mar. 14, 2008
(86) PCT No.: PCT/KR2008/001433

§ 371 Date: Dec. 23, 2009

Related U.S. Application Data
(60) Provisional application No. 60/895,117, filed on Mar. 15, 2007.

(30) Foreign Application Priority Data
Apr. 18, 2007 (KR) 10-2007-0037954

(51) Int. Cl. H04W 72/00; H04W 4/00

(52) U.S. Cl. 370/329; 370/328

(57) ABSTRACT

A method of transmitting data in a wireless communication system includes configuring a data operation pattern for a plurality of data blocks with variable size, generating the plurality of data blocks according to the data operation pattern and transmitting the plurality of data blocks. Although a data generating time or size is irregular, data can be transmitted without the need for additional signaling by predicting or deciding the pattern of the data. Although a data generating time or size is not constant, repetitive signaling is not required every transmission.

### TECHNICAL FIELD

The present invention relates to wireless communication, and more particularly, to a method of transmitting data based on a predicted traffic pattern in a wireless communication system.

### BACKGROUND ART

Third generation partnership project (3GPP) mobile communication systems based on a wideband code division multiple access (WCDMA) radio access technique are widely spread all over the world. High-speed downlink packet access (HSDPA) that can be defined as a first evolutionary stage of WCDMA provides 3GPP with wireless access technique that is highly competitive in the mid-term future. However, since requirements and expectations of users and service providers are continuously increased and developments of competing radio access techniques are continuously in progress, new technical evolutions in 3GPP are required to secure competitiveness in the future. Reduction of cost per bit, increase of service availability, flexible use of frequency bands, simple structure and open interface, proper power consumption of a user equipment, and the like are defined as requirements.

In order to efficiently transmit or receive data between a network and a user equipment, scheduling is necessary. Scheduling is basically performed by the network. The network informs the user equipment of its decided scheduling information. Scheduling information includes information on allocation of radio resources.

A user equipment requests scheduling information from the network in order to transmit or receive data. After scheduling information is received from the network, the user equipment transmits or receives data according to the scheduling information.

However, if the user equipment must receive scheduling information from the network whenever data is received or transmitted, repetitive signaling is required. Hence, overall capacity can be reduced due to such signaling.

There are various types of data and a specific size of data can be transmitted for a specific time period. For example, VoIP (Voice Over Internet Protocol) refers to a series of communication services in which voice data is converted into a data packet, enabling voice call as in a telephone call. In general, a specific size of data is transmitted for a specific time period. In the case of VoIP, scheduling information is previously set between a network and a user equipment so that a specific size of data can be transmitted for a specific time period.

In order to increase data transmission efficiency, a data compression technique is used. If data is compressed, the size of compressed data is smaller than that of original data, which enables more data to be transmitted. However, if data is compressed, the size of original data is changed, which makes it impossible to employ conventional scheduling information in which a specific size of data is transmitted for a specific time period.

Accordingly, there is a need for a method which is able to transmit data while minimizing signaling although data compression is performed.

### DISCLOSURE OF INVENTION

### Technical Problem

The present invention provides a method of transmitting data, in which radio resources are allocated on the basis of a predicted data operation pattern and the data is transmitted through the radio resources.

### Technical Solution

In one aspect, a method of transmitting data in a wireless communication system is provided. The method includes configuring a data operation pattern for a plurality of data blocks with variable size, generating the plurality of data blocks according to the data operation pattern and transmitting the plurality of data blocks.

In another aspect, a method of transmitting data in a wireless communication system is provided. The method includes transmitting a message including a data operation pattern, the data operation pattern comprising information on generating a plurality of data blocks with variable size, generating the plurality of data blocks according to the data operation pattern and transmitting the plurality of data blocks.

In still another aspect, a method of receiving data in a wireless communication system is provided. The method includes receiving a message including a data operation pattern, the data operation pattern comprising information on generating a plurality of data blocks with variable size and receiving the plurality of data blocks according to the data operation pattern.

In still another aspect, a user equipment includes a RF (Radio Frequency) unit for transmitting and receiving radio signals and a processor coupled to the RF unit and configured to transmit a request for allocating radio resources according to a data operation pattern, the data operation pattern comprising information on generating a plurality of data blocks with variable size, generate the plurality of data blocks according to the data operation pattern and transmit the plurality of data blocks through the allocated radio resources.

### Advantageous Effects

Although a data generating time or size is irregular, data can be transmitted without the need for additional signaling by predicting or deciding the pattern of the data. Although a data generating time or size is not constant, additional signaling is not required every transmission. It is effective in transmission of VoIP packets employing the header compression scheme.

### BRIEF DESCRIPTION OF THE DRAWINGS

FIG. 1 is a block diagram showing a wireless communication system.

FIG. 2 is a block diagram showing constitutional elements of a user equipment.

FIG. 3 is a block diagram showing control plane of the radio interface protocol.

FIG. 4 is a block diagram showing user plane of the radio interface protocol.

FIG. 5 illustrates a dynamic scheduling scheme in downlink transmission.

FIG. 6 illustrates static scheduling scheme in uplink transmission.

FIG. 7 illustrates static scheduling scheme in uplink transmission.

FIG. 8 shows a change in the header size of a RTP/UDP/IP packet when ROHC is applied.

FIG. 9 shows a change in the header size of the RTP/UDP/IP packet generated when ROHC is used.

FIG. 10 is a block diagram illustrating a method of transmitting data in accordance with an embodiment of the present invention.

FIG. 11 is a flowchart illustrating a method of transmitting data in accordance with an embodiment of the present invention.

FIG. 12 is a flowchart illustrating a method of transmitting data in accordance with an embodiment of the present invention.

### MODE FOR THE INVENTION

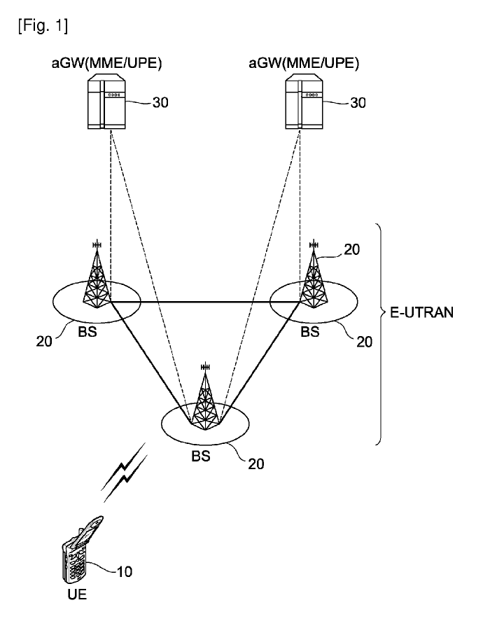

FIG. 1 is a block diagram showing a wireless communication system. This may be a network structure of an E-UMTS (Evolved-Universal Mobile telecommunications System). The E-UMTS system may be referred to as an LTE (Long-term Evolution) system. The wireless communication system can widely be deployed to provide a variety of communication services, such as voices, packet data, and the like.

Referring to FIG. 1, an E-UTRAN (Evolved-UMTS Terrestrial Radio Access

Network) includes base stations (BS) 20. A user equipment 10 can be fixed or mobile and can be referred to as another terminology, such as a MS (Mobile Station), a UT (User Terminal), a SS (Subscriber Station), wireless device, or the like. The base station 20 generally is a fixed station that communicates with the user equipment 10 and can be referred to as another terminology, such as an e-NB (evolved-NodeB), BTS (Base Transceiver System), access point, or the like. There are one or more cells within the coverage of the base station 20. An interface for transmitting user traffics or control traffics can be used between base stations 20. Hereinafter, downlink means a communication from the base station 20 to the user equipment 10, and uplink means a communication from the user equipment 10 and the base station 20.

The base station 20 provides the user equipment 10 with termination points of a user plane and a control plane. The base stations 20 can be connected with each other through an X2 interface, and adjacent base stations 20 can have a network of a meshed structure where the X2 interface always exists.

The base station 20 is connected to an EPC (Evolved Packet Core), further specifically, to an aGW (access Gateway) 30 through an S1 interface. The aGW 30 provides a termination point of session and mobility management function of the user equipment 10. A plurality of nodes of the base stations 20 and the aGWs 30 can be connected to each other in a many-to-many relation through the S1 interface. The aGW 30 can be divided into a part for processing user traffics and a part for processing control traffics. In this case, the part for processing traffics of a new user and the part for processing a control traffic can communicate with each other through a new interface. The aGW 30 also can be referred to as an MME/UPE (Mobility Management Entity/User Plane Entity).

Layers of the radio interface protocol between the user equipment and the base station can be classified into L1 (a first layer), L2 (a second layer), and L3 (a third layer) based on the lower three layers of the Open System Interconnection (OSI) model that is well-known to communication systems. The physical layer belonging to the first layer provides information transfer service using a physical channel. A radio resource control (RRC) layer belonging to the third layer serves to control radio resources between the user equipment and the network. The user equipment and the network exchange RRC messages via the RRC layer. The RRC layer can be distributed among network nodes, such as the base station, the aGW, and the like. Or the RRC layer can be located only in the base station or the aGW.

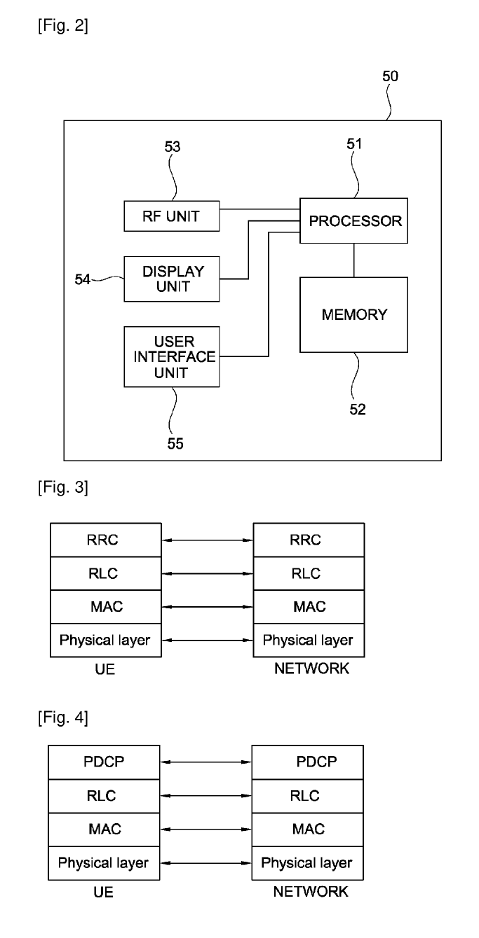

FIG. 2 is a block diagram showing constitutional elements of a user equipment. A user equipment 50 includes a processor 51, memory 52, an RF unit 53, a display unit 54, and a user interface unit 55. The memory 52 coupled with the processor 51 stores operating systems, applications, and general files. The display unit 54 displays a variety of information on the user equipment and may use a well-known element, such as an LCD (Liquid Crystal Display), OLED (Organic Light Emitting Diode), or the like. The user interface unit 55 can be configured with a combination of well-known user interfaces such as a keypad, touch screen, and the like. The RF unit 53 coupled to the processor 53 transmits and/or receives radio signals.

Functions of layers of the radio interface protocol can be implemented in the processor 51. The processor 51 can provide control plane and user plane.

The radio interface protocol includes a physical layer, a data link layer, and a network layer in horizontal plane, and user plane for transmitting user data and control plane for transferring control signals in vertical plane.

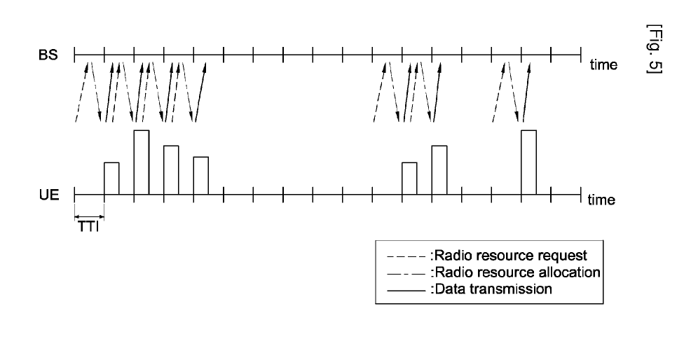

FIG. 3 is a block diagram showing control plane of the radio interface protocol. FIG. 4 is a block diagram showing user plane of the radio interface protocol. FIGS. 3 and 4 show the structure of the radio interface protocol between the user equipment and the E-UTRAN based on the 3GPP radio access network specification.

Referring to FIGS. 3 and 4, a physical layer, i.e., the first layer, provides an information transfer service to upper layers through a physical channel. The physical layer is connected to the MAC (Medium Access Control) layer, i.e., an upper layer of the physical layer, through a transport channel. Data are moved between the MAC layer and the physical layer through the transport channel. The transport channel can be divided into a dedicated transport channel and a common transport channel. Between different physical layers, i.e., the physical layer of a transmitter and the physical layer of a receiver, data are moved through the physical channel.

The MAC layer provides a service to a RLC (Radio Link Control) layer, i.e., an upper layer of the MAC layer, through a logical channel. The MAC layer maps a logical channel to a transport channel and performs logical channel multiplexing by which a plurality of logical channels maps to a single transport channel. The MAC layer is coupled with the RLC layer through the logical channel. The logical channel can be classified to a control channel for transmitting information on the control plane and a traffic channel for transmitting information on the user plane.

The RLC layer in the second layer adjusts the size of data to facilitate data transmission in lower layers by performing segmentation and concatenation of data. The RLC layer provides various operation modes to guarantee quality of service (QoS) at each radio bearer (RB). The RLC layer can perform automatic repeat and request (ARQ) for reliable data transmission.

A PDCP (Packet Data Convergence Protocol) belonging to the second layer performs header compression function. When transmitting an Internet Protocol (IP) packet such as an IPv4 packet or an IPv6 packet, the header of the IP packet may contain relatively large and unnecessary control information. The PDCP layer reduces the header size of the IP packet so as to efficiently transmit the IP packet.

A RRC (Radio Resource Control) layer belonging to the third layer is defined only on the control plane. The RRC layer serves to control the logical channel, the transport channel, and the physical channel in association with configuration, reconfiguration, and release of Radio Bearers (RBs). The RB is a service provided by the second layer for data transmission between a user equipment and a E-UTRAN. The RB means a logical path provided by the first and second layers of the radio protocol to transfer data between a user equipment and the E-UTRAN. Establishing the RB means a procedure of specifying characteristics of the radio protocol layers and channels needed to provide a specific service and setting specific parameters and an operation method of each layer and channel.

Hereinafter, a scheduling method in accordance with an embodiment of the present invention is disclosed.

Scheduling is basically performed by a network (for example, a base station). The network informs a user equipment of its decided scheduling information. The user equipment first receives scheduling information from the network in order to transmit or receive data, and transmits or receives data according to the received scheduling information. Scheduling information is information necessary to transmit data in a radio interface, and can include (1) identifier information such as a user equipment identifier or a group identifier, (2) radio resource assignment information such as time and frequency, (3) duration of assignment, that is, a valid duration of assigned radio resources, (4) multi-antenna information pertaining to MIMO (Multiple Input Multiple Output) or beam forming, (5) modulation information such as QPSK (Quadrature Phase Shift Keying), (6) payload size such as packet size, (7) information of a HARQ (Hybrid Automatic Repeat Request) process number, a redundancy version, and asynchronous HARQ such as a new data indicator, (8) synchronous HARQ information such as a retransmission sequence number.

In general, scheduling is largely classified into dynamic scheduling and static scheduling. In accordance with the dynamic scheduling scheme, downlink scheduling information or uplink scheduling information is received whenever data is transmitted. Data is transmitted according to received downlink scheduling information or uplink scheduling information. In accordance with the static scheduling scheme, in an initial stage where a network and a user equipment establishes a RB, scheduling information for transmitting a number of data is previously set through a RRC message, etc. The user equipment (or the network) transmits or receives data by employing the preset scheduling information when transmitting or receiving data.

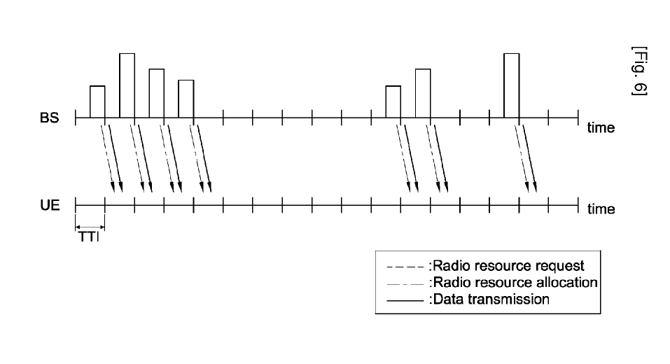

FIG. 5 shows the dynamic scheduling scheme in uplink transmission.

Referring to FIG. 5, a user equipment checks whether there is data to be transmitted to a base station every TTI (Transmission Time Interval). The TTI refers to a time unit in which data is transmitted (scheduled) at once. If, as a result of the check, there exists data to be transmitted, the user equipment requests radio resources from the base station. If the radio resource request is received from the user equipment, the base station determines whether available resources exist. If, as a result of the determination, available resources exist, the base station allocates proper radio resources to the user equipment. The user equipment transmits data according to the allocated radio resources.

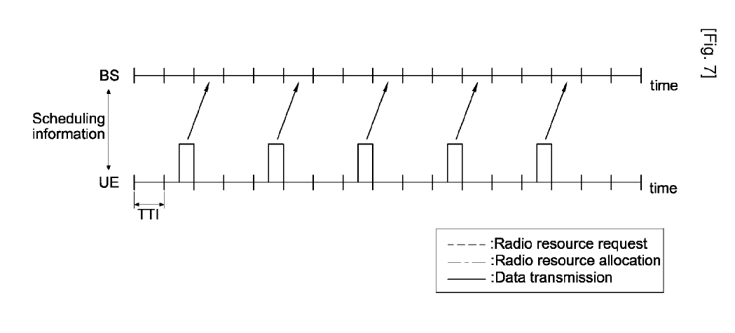

FIG. 6 shows the dynamic scheduling scheme in downlink transmission.

Referring to FIG. 6, a base station checks whether there is data to be transmitted to a user equipment every TTI. If, as a result of the check, there exists data to be transmitted, the base station allocates downlink radio resources to the user equipment and transmits data to the user equipment according to the allocated radio resources. The user equipment receives data according to the allocated radio resources.

The dynamic scheduling scheme must request and be allocated radio resources whenever data is transmitted and, therefore, requires lots of signaling. The method of transmitting or receiving data by employing scheduling information every time when data is transmitted is advantageous when various sizes of data, such as web browsing, are transmitted irregularly, but is disadvantageous in that signaling is increased since scheduling information is required every time.

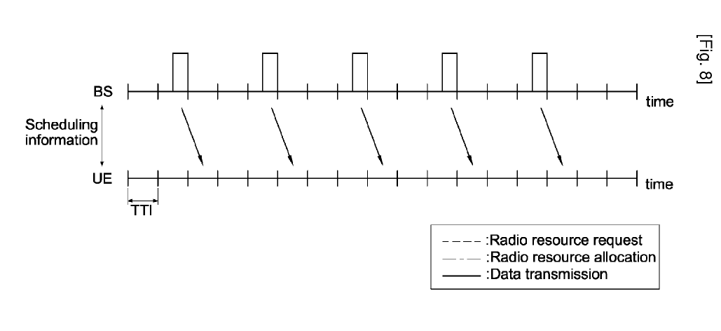

FIG. 7 shows the static scheduling scheme in uplink transmission.

Referring to FIG. 7, a base station and a user equipment exchange uplink scheduling information. The user equipment transmits data having a preset packet size on a preset transmission time according to uplink scheduling information. Here, data having a constant size is transmitted uplink at 3 TTI intervals.

FIG. 8 shows the static scheduling scheme in downlink transmission.

Referring to FIG. 8, a base station and a user equipment exchange downlink scheduling information. The base station transmits data having a preset packet size on a preset transmission time according to downlink scheduling information. Here, data having a constant size is transmitted downlink at 3 TTI intervals.

If data having a constant size is transmitted on a constant time such as VoIP, it may not be said that the dynamic scheduling scheme where signaling is performed every transmission uses radio resources inefficiently. Thus, it can be said that the static scheduling scheme is suitable to transmit data having a constant size on a constant time.

Meanwhile, as described above, the PDCP layer performs header compression.

Header compression is a scheme of reducing the header size based on the fact that most IP packets belonging to the same packet stream are not changed. The header compression scheme is a method of reducing the overhead of IP headers by storing fields whose values are not changed in the compressor of a transmitter and the decompressor of a receiver in the form of a context and then transmitting only changed fields after the context is formed. In the initial stage of header compression, the compressor transmits the full header packet in order to form a context with respect to a corresponding packet stream in the decompressor. Thus, there is no profit due to header compression. However, after the context is formed in the decompressor, the compressor can transmit only compressed header packets and, therefore, a profit thereof is significant.

ROHC (Robust Header Compression), that is, one of the header compression schemes is used to reduce header information of real-time packets such as RTP (Real-time Transport Protocol)/UDP (User Datagram Protocol)/IP (Internet Protocol). The RTP/UDP/IP packet refers to a packet to which pertinent headers of data coming down from an upper side are attached after the data passes through RTP and UDP and IP, and includes various and lots of header information through which data is transferred to a destination via an Internet and then recovered. In general, the header size of the RTP/UDP/IP packet 40 bytes in IPv4 (IP version 4) and 60 bytes in IPv6 (IP version 6). If the header is compressed using ROHC, the size of the header can be reduced to 1 to 3 bytes.

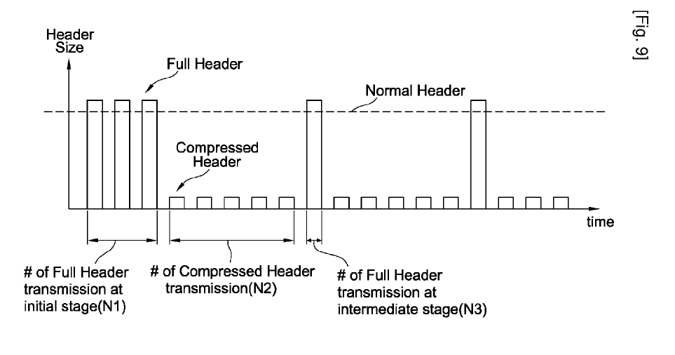

FIG. 9 shows a change in the header size of the RTP/UDP/IP packet generated when ROHC is used. In general, the full header includes additional information for forming a context and has a size slightly larger than that of a normal header.

Referring to FIG. 9, when a packet stream is first transmitted, the full header is transmitted in order to form a context since the context is not formed both in the compressor and the decompressor. If some degree of the full header is transmitted (it is assumed that the number of the full header that is transmitted at the initial stage is N1), the context is formed. A compressed header is then transmitted. However, the context may be damaged due to causes, such as packet loss, during the transmission of the header. Thus, it is necessary to transmit the full header at proper intervals. It is assumed that the number of the compressed header that is transmitted between the full headers is N2 and the number of the full header that is transmitted at the intermediate stage is N3. The full header and the compressed header are transmitted repeatedly at constant TTI intervals.

A VoIP packet is a representative packet of the RTP/UDP/IP type and is transmitted as a constant size on a constant time. Thus, it can be said that the above static scheduling method is effective. However, if the header compression scheme is used in order to reduce the header size of the VoIP packet, the size of the header is changed as shown in FIG. 9, so a packet having a different size is generated. This makes it difficult to use the static scheduling method used only for transmission of data having a constant packet size.

A VoIP packet requires header compression. A VoIP packet has a header size too larger than that of real data. For example, the entire header size of the RTP/UDP/IP packet used in VoIP is 40 bytes in the case of IPv4 and 60 bytes in the case of IPv6, whereas the size of a pure data portion called payload is at most 15 to 20 bytes. Thus, it can be said that header compression for reducing the size of the header is indispensable. If the header is compressed using ROHC, the header size can be reduced from 40 or 60 bytes to 1 to 3 bytes. Consequently, in VoIP, header compression is indispensable. Hence, there is a need for a method that does not generate lots of signaling like static scheduling while header compression is applied in order to support VoIP effectively.

There is presented a pattern scheduling method of previously deciding a pattern of transmitted data in any data stream and allocating radio resources according to the pattern. That is, a user equipment and a network set a traffic pattern for data generation when a RB is set up and transmit or receive data according to the set pattern without the need for additional scheduling information when real data is transmitted and received.

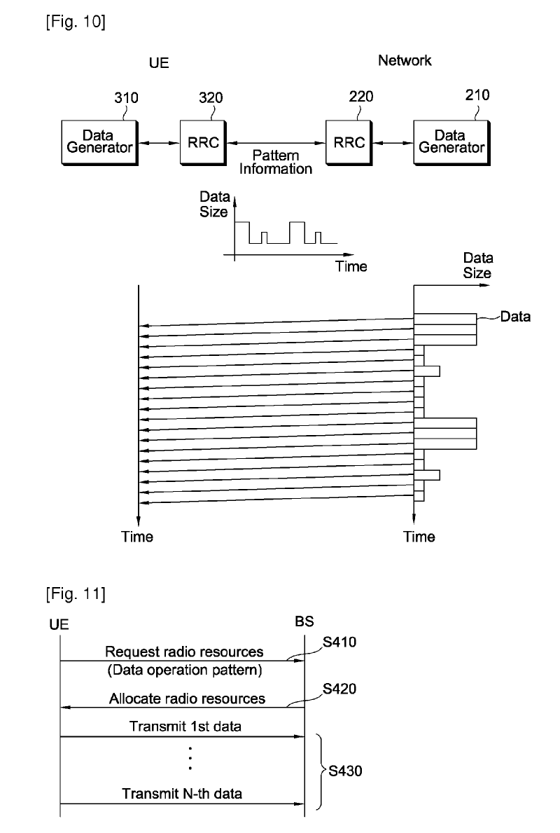

FIG. 10 is a block diagram illustrating a method of transmitting data in accordance with an embodiment of the present invention.

Referring to FIG. 10, in the case of uplink transmission, a RRC 320 of a user equipment is an entity which sets a data operation pattern of a data generator 310 when establishing a RB or receives information about the data operation pattern set by the data generator 310. The data generator 310 is an entity, which directly generates data or processes received data in order to generate a new type of data, and can include, for example, a codec or header compressor, etc. In the case of downlink transmission, a RRC 220 of a network sets a data operation pattern of a data generator 210 when establishing a RB or receives information about the data operation pattern set by the data generator 210.

When setting the data operation pattern, the user equipment or the network can decide parameters of the data generators 210 and 310 and directly control the data operation pattern. Alternatively, the data generators 210 and 310 may decide the data operation patterns themselves and inform the RRC 320 of the user equipment or the RRC 220 of the network of the parameters. The data operation pattern related parameters can include a data generating time, a generated data size and the like, and may also include various pieces of information such as the number of data having a specific size, which is generated, the cycle of data having a specific size, which is generated, and the type of a data size that is generated on a specific time.

The RRC 320 of the user equipment and the RRC 220 of the network exchange information about the data operation patterns. The parameters of the set data operation pattern can be exchanged through a RRC message. The RRC 320 of the user equipment and the RRC 220 of the network set lower layers, such as PHY, MAC, RLC and PDCP, by employing the information about the set data operation pattern.

If data transmission begins, the data generators 210 and 310 of the transmitter generate data according to a previously set data operation pattern. That is, the data generators 210 and 310 of the transmitter generate data having a preset size on a preset time and transmit the data through a radio interface. The receiver also receives data based on preset information.

In the case where ROHC is applied to VoIP, if the presented scheduling method is used, scheduling can be performed effectively while reducing signaling. In VoIP, basically, packets having a constant size (55 to 60 bytes or 75 to 80 bytes) are generated at constant time intervals (for example, 20 ms). If header compression is performed, a generating time is not changed, but the size of the generated packet is changed. However, if several parameters of ROHC are previously set, the size pattern of a generated packet can be predicted, so the pattern scheduling method can be used.

A parameter that decides a pattern is various. However, if parameters, such as the number N1 of the full header that is transmitted in the initial stage, the number N2 of the full header that is transmitted between the full headers, the number N3 of the full header that is transmitted in the intermediate stage, etc. in FIG. 9 are decided and previously exchanged, VoIP packets can be transmitted or received effectively even without other scheduling information. Time information, such as a transmission time or cycle of the full header and a transmission time of the compressed header, can also be used as parameters.

FIG. 11 is a flowchart illustrating a method of transmitting data in accordance with an embodiment of the present invention.

Referring to FIG. 11, a user equipment requests radio resources from a base station (S410). A radio resource request message can include a data operation pattern. The data operation pattern can include a transmission time of data to be transmitted, the size of data, and soon. The transmission time of the data may be varied depending on the type of data.

The base station allocates radio resources according to the data operation pattern (S420).

The user equipment sequentially transmits first to N-th data (N>1) according to the data operation pattern by employing the allocated radio resources (S430). Although the sizes of the first to N-th data are changed differently due to header compression, the user equipment can transmit plural data without the need for additional signaling by previously exchanging the data operation patterns.

Here, it has been described that the data operation pattern is transmitted with it being included in the radio resource request message. However, the data operation pattern can be transmitted to the base station through an additional message.

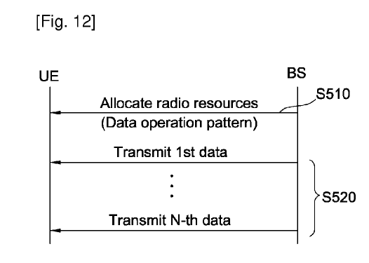

FIG. 12 is a flowchart illustrating a method of transmitting data in accordance with an embodiment of the present invention.

Referring to FIG. 12, a base station prepares a data operation pattern, allocates radio resources according to the data operation pattern, and transmits the radio resources to a user equipment (S510).

The base station sequentially transmits first to Nth data (N>1) according to the data operation pattern by employing the allocated radio resources (S520). Although the sizes of the first to N-th data are changed differently due to header compression, the base station can transmit plural data without the need for additional signaling by previously exchanging the data operation patterns.

Here, it has been described that the data operation pattern is transmitted with it being included in the radio resource allocation message. However, the data operation pattern can be transmitted to the base station through an additional message.

The functions described in connection with the embodiments disclosed herein may be performed by implemented by hardware, software or a combination thereof. The hardware may be implemented by a microprocessor, a controller, an application specific integrated circuit (ASIC) and a processor. Design, development and implementation of the software are well known to those skilled in the art based on the detailed description.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are intended to be embraced by the appended claims.

1. A method of transmitting data in a wireless communication system, the method comprising:
configuring a data operation pattern for a plurality of data blocks with variable size;
generating the plurality of data blocks according to the data operation pattern; and
transmitting the plurality of data blocks.

2. The method of claim 1, wherein a data block includes a header, and the size of the data block varies as the size of the header varies.

3. The method of claim 2, wherein the header is a full header or a compressed header.

4. The method of claim 3, wherein the data operation pattern comprises the number of transmission of the full header and the number of transmission of the compressed header.

5. The method of claim 1, wherein each of the plurality of data blocks is transmitted at a predetermined period.

6. The method of claim 5, wherein the predetermined period is obtained from the data operation pattern.

7. The method of claim 1, wherein the plurality of data blocks is generated in a PDCP (Packet Data Convergence Protocol) layer.

8. The method of claim 1, wherein the data operation pattern comprises the sizes of the plurality of data blocks and the generating period of the plurality of data blocks.

9. A method of transmitting data in a wireless communication system, the method comprising:
transmitting a message including a data operation pattern, the data operation pattern comprising information on generating a plurality of data blocks with variable size;
generating the plurality of data blocks according to the data operation pattern; and
transmitting the plurality of data blocks.

10. The method claim 9, wherein the message is a RRC (Radio Resource Control) message.

11. The method of claim 9, wherein a data block includes a header, and the size of the data block varies as the size of the header varies.

12. The method of claim 11, wherein the header is a full header or a compressed header, and the data block is generated in a PDCP layer.

13. A method of receiving data in a wireless communication system, the method comprising:
receiving a message including a data operation pattern, the data operation pattern comprising information on generating a plurality of data blocks with variable size; and
receiving the plurality of data blocks according to the data operation pattern.

14. The method of claim 13, wherein the data operation pattern comprises information on the sizes of the plurality of data blocks and information on the generating period of the plurality of data blocks.

15. A user equipment comprising:
a RF (Radio Frequency) unit for transmitting and receiving radio signals; and
a processor coupled to the RF unit and configured to transmit a request for allocating radio resources according to a data operation pattern, the data operation pattern comprising information on generating a plurality of data blocks with variable size;
generate the plurality of data blocks according to the data operation pattern; and
transmit the plurality of data blocks through the allocated radio resources.

16. The user equipment of claim 15, wherein the data operation pattern comprises information on the sizes of the plurality of data blocks and information on the generating period of the plurality of data blocks.
